(19) United States
(12) Patent Application Publication
(10) Pub. No.: US 2006/0106760 A1
(43) Pub. Date: May 18, 2006

(54) Method and apparatus of inter-document data retrieval

(76) Inventor: Netzer Moriya, Ramat-Hasharon (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/977,281

(22) Filed: Oct. 29, 2004

(51) Int. Cl. G06F 7/00; G06F 17/30

(52) U.S. Cl. 707/3

(57) ABSTRACT

A data retrieval method that includes: (i) receiving a query that comprises a set of keywords and a desired document responsive keyword association level; and (ii) searching for at least a group of documents that comprises the set of keywords, whereas each document of the group does not comprise the set of keywords; and whereas an association level between the documents of the groups corresponds to the desired association level.

### BACKGROUND OF THE INVENTION

During the last decades the importance of information as well as the amount of information has dramatically increased. A typical Internet search engine can access more than 10⁹ web pages. The rapid development of telecommunications and computers technology enables millions of people to search for information using a variety of client devices. Modem data mining and data management techniques evolved for allowing access to relevant information.

In view of the vast amount of information various search engines, data mining techniques and data retrieval methods were developed. They are aimed to locate relevant documents out of a large document database. Common search methods include keyword-based methods, vector-based methods and the like.

The following U.S. patents, all being incorporated herein by reference, provide a brief view of some state of the art search methods and devices as well of some state of the art data retrieval methods and devices: U.S. Pat. No. 6,523,026 of Gillis, U.S. Pat. No. 6,681,219 of Aref, U.S. Pat. No. 6,721,728 of McGreevy, U.S. Pat. No. 6,718,324 of Edlund et al., U.S. Pat. No. 6,681,217 of Lewak, U.S. Pat. No. 6,151,610 of Senn et al., U.S. Pat. No. 6,026,388 of Liddy et al. U.S. Pat. No. 6,012,083 of Savitzky et al., U.S. Pat. No. 6,006,221 of Liddy et al., U.S. Pat. No. 5,963,940 of Liddy et al., U.S. Pat. No. 5,412,807 of Moreland, U.S. Pat. No. 5,933,145 of Meek, and U.S. Pat. No. 5,915,251 of Burrows et al.

One keyword-based search method is known as keyword proximity search. It allows a client to define a search query that includes two or more keywords and a distance between said keywords. Any document that includes all the keywords positioned within said distance can be provided as a search result.

The distance between the keywords can be fixed, set by a client or defined as a default value that can be altered by the client. The NEAR command is typically used at keyword proximity search queries and can be accompanied by the distance between said keywords.

There is a growing need to provide an efficient data retrieval method.

### SUMMARY OF THE INVENTION

The invention provides method for data retrieval. The method includes: (i) receiving a query that comprises a set of keywords and a desired document responsive keyword association level; and (ii) searching for at least a group of documents, whereas each document of the group includes at least one keywords of the set but does not include the whole set of keywords, but the group of documents as a whole includes the set of keywords; and whereas an association level between the documents of the groups corresponds to the desired association level.

The invention provides method for data retrieval. The method includes: (i) receiving a search query that comprises a set of keywords and a desired document responsive keyword association level; (ii) searching at least one document that comprises all the set of keywords; and (iii) searching for at least one group of documents that comprises the set of keywords, whereas each document of the group does not comprise the set of keywords; and whereas a document responsive keyword association level between the keywords within each group corresponds to the desired association level.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates a data retrieval system according to an embodiment of the invention;

FIG. 2 illustrates two documents that include two keywords as well as metadata, according to an embodiment of the invention; and

FIGS. 3 and 4 are flow charts of methods for data retrieval, according to various embodiments of the invention.

### DETAILED DESCRIPTION OF THE INVENTION

For simplicity of explanation the following detailed description refers to search queries that include two keywords. It is noted that method can be applied mutates mutandis to search queries that include more than two keywords.

The usage of association level parameters allows a definition of a multi-dimensional relation between keywords. Thus, instead of providing a simple NEAR operation that can associate between keywords that belong to the same document, the method can link between keywords in response to indirect correlation between documents, document databases and the like.

The term “document” as used throughout the specification relates to a set, group or any other arrangement of multiple signals representing text, graphics, video, audio or any digital based signal that may carry and valuable information or a combination of two or more of said signals. The signals can be in various formats, including, for example, HTML format, MPEG format, and the like. It is noted that at least one document data base is searched and that said databases can be stored in one or more locations, either close to each other or remotely positioned. Examples for a document can include a book, an article, a song, one of more image frames and the like.

The term “metadata” as used throughout the specification relates to information representative to a characteristic, parameter or other attribute of a certain piece of information.

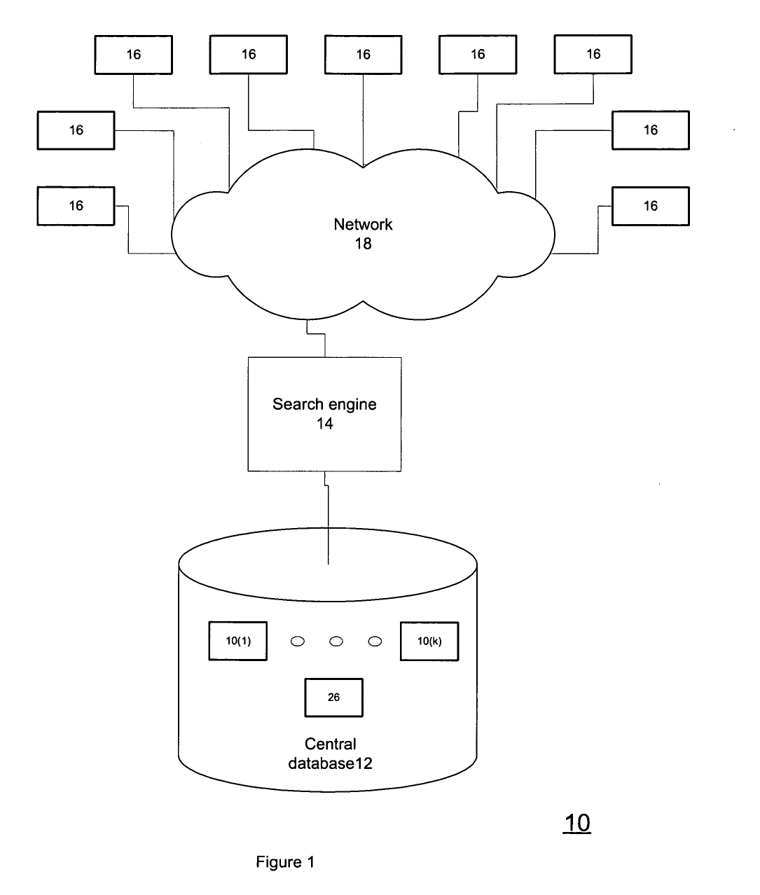

FIG. 1 illustrates a data retrieval system 10 according to an embodiment of the invention. For convenience of explanation it is assumed that multiple client devices are connected via a network to a central database.

It is noted that the data retrieval method can me executed in various systems that differ from system 10. For example, the multiple documents that are accessed during the data retrieval process can be stored in multiple databases. Yet for another example, the client can perform a search on a local server or computer, and the like. Yet for a further example the client devices can be connected to the central database or to a complex of distributed databases via different types of networks.

System 10 includes a central database 12 that stores multiple documents 10(1)-10(k), as well as metadata 26 associated with these documents. This central database 12 can include multiple storage components as well as load balancing components, and the like. The central data base can include cache memories, firewall servers and the like.

The central database 12 is connected to a search engine 14 that in turn can include multiple hardware, software and middleware components. The search engine 14 is connected to multiple client devices 16 via network 18. It is noted that the client devices can include computers, personal data accessories, cellular phones, set-top-boxes and the like. Usually, a client device 16 includes dedicated software that allows the client to send search queries and receive results.

Network 18 can include multiple networks, including access networks, local area networks and the like. Network 18 can be utilize various communication techniques such as but not limited to wireless communication, terrestrial communication, satellite communication, and the like. Network 18 can utilize optical communication techniques, radio frequency communication techniques, and even a combination of both. A combination of both can be found at hybrid fiber coax networks that are connected to cable modems and to set top boxes.

Search engine 14 is capable of receiving a search query that includes a set of keywords and a desired document responsive keyword association level and is further adapted to search for at least one group of documents within a document database. Each group of documents fulfills the following conditions: (i) the whole set of keywords is included within the group; (ii) each document of the group does not include the whole set of keywords, and (iii) an document responsive keyword association level between the keywords within the group documents of the groups corresponds to the desired association level. For example, the association level is either equal to said level or higher than that level. It is noted that if the document database does not include documents that fulfill the search query then the group of documents is an empty group.

Conveniently, the invention search engine 14 is capable of handling other search queries. According to various embodiments of the invention search engine 14 is capable of performing a prior art keyword proximity search.

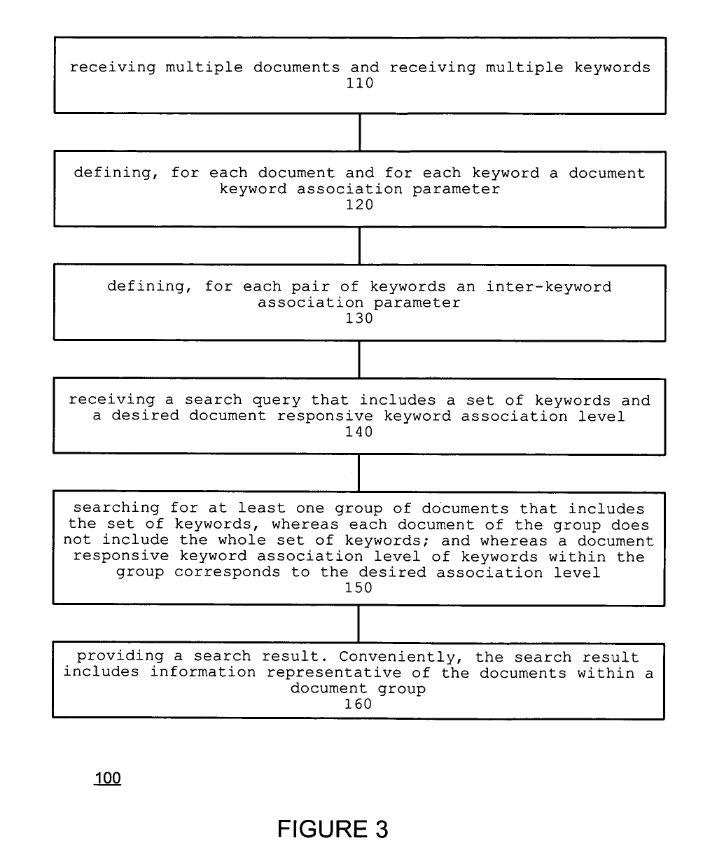

FIG. 3 is a flow chart of method 100 for data retrieval, according to an embodiment of the invention.

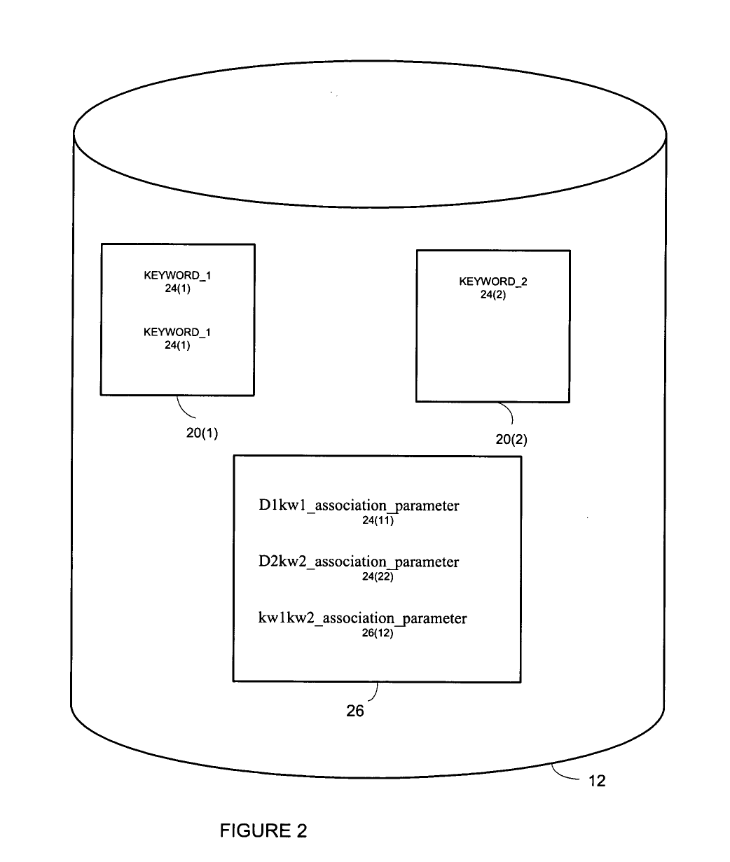

Method 100 starts by stage 110 of receiving multiple documents and receiving multiple keywords. Referring to the example of FIG. 2, central data base stores a large amount of documents, but only two documents 20(1) and 20(2) are illustrated, for simplicity of explanation. A first keyword keyword_1 24(1) appears twice in first document 20(1). A second keyword keyword_2 24(2) appears once within the second document 20(2).

Stage 110 is followed by stage 120 of defining, for each document and for each keyword a document keyword association parameter. The document keyword association parameter can reflect the correlation between a certain document and a certain keyword.

The definition can require human intervention but this is not necessarily so and can be done automatically, without human intervention. For example, the parameter can be responsive to the number of keyword appearance within the document, to the location of the keyword within the document (for example whether the keyword appears in the title of the document, the abstract of the document and the like), to a ratio between that keyword and other keywords or words within the document and the like.

Referring to the example set forth in FIG. 2, stage 120 includes defining a first document first keyword association parameter (denoted D1k1_A_P) 24(11) that has a certain value. It is assumed that D1k1_A_P=50, reflecting a medium correlation between the document and the keyword. Stage 120 also includes defining a second document second keyword association parameter (denoted D2k2_A_P) 24(22) that has a certain value. It is assumed that each of the association parameters can range between zero (lowest correlation level) and one-hundred (highest correlation level. It is further assumed that D2k2_A_P=10), reflecting a low correlation between the second document and the second keyword.

Stage 120 is followed by stage 130 of defining, for each pair of keywords an inter-keyword association parameter. Referring to the example set forth in FIG. 2, stage 120 includes defining a first keyword second keyword inter-keyword association parameter (denoted k1k2_A_P) 26(12) that has a certain value. We assume that k1k2_A_P=30, reflecting a relatively low correlation between the first and second keywords.

Stage 130 is followed by stage 140 of receiving a search query that includes a set of keywords and at least one desired document responsive keyword association level (denoted desired_level). The at least one received document responsive keyword association level can define a low association level threshold, a high association level threshold and even a range of association levels. It is assumed that the search query included keyword_1 and keyword_2 and that desired_level is a low association level threshold and that it equals eighty.

Stage 140 is followed by stage 150 of searching for at least one group of documents that as a whole includes the set of keywords, whereas each document of the group includes at least one keyword but does not include the whole set of keywords; and whereas a document responsive keyword association level of keywords within the group corresponds to the desired association level.

The document responsive keyword association level (keyword_level) of keywords is responsive to a corresponding inter-keyword association parameter and to corresponding document keyword association parameter. The relationship between said association parameters and the document responsive keyword association level can be linear, non-linear and the like.

For simplicity of explanation we assume that the document responsive keyword level is the sum of the association parameters: keyword_level=k1k2_A_P+D1k1_A_P+D2k2_A_P.

In our example keyword_level=50+10+30=90. Keyword_level>desired_level, thus the search result will include document_1 and document_2. If, for example, keyword_level was a high association level threshold then the search result was negative.

According to an embodiment of the invention the various association parameters can be updated in response to the search results or even in response to client inputs or actions. For example, if a client received a search result that mentioned various documents, the relevancy of these documents can be learnt from the mere retrieval of these documents by the client, or even by an additional client operation such as storage of said document, the initiation of other search queries that mention the document and the like. It is noted that the manner in which various association parameters are related to each other, as well as the manner in which the search is conducted can be altered.

Yet for another example the client can provide input relating to the correlation between the retrieved documents. The input can be verbal (“relevant”, “not relevant”, “slightly relevant”) or can include a rank or grade reflecting the correlation between documents and keywords and even between keywords, as viewed by the client.

Stage 150 is followed by stage 160 of providing a search result. Conveniently, the search result includes information representative of the documents within a document group. Said information can provide the names of the documents, their location, a link for fast retrieval of the documents, and the like. The information can further provide information about the relevant association parameters, and can also rank the group of documents and the like.

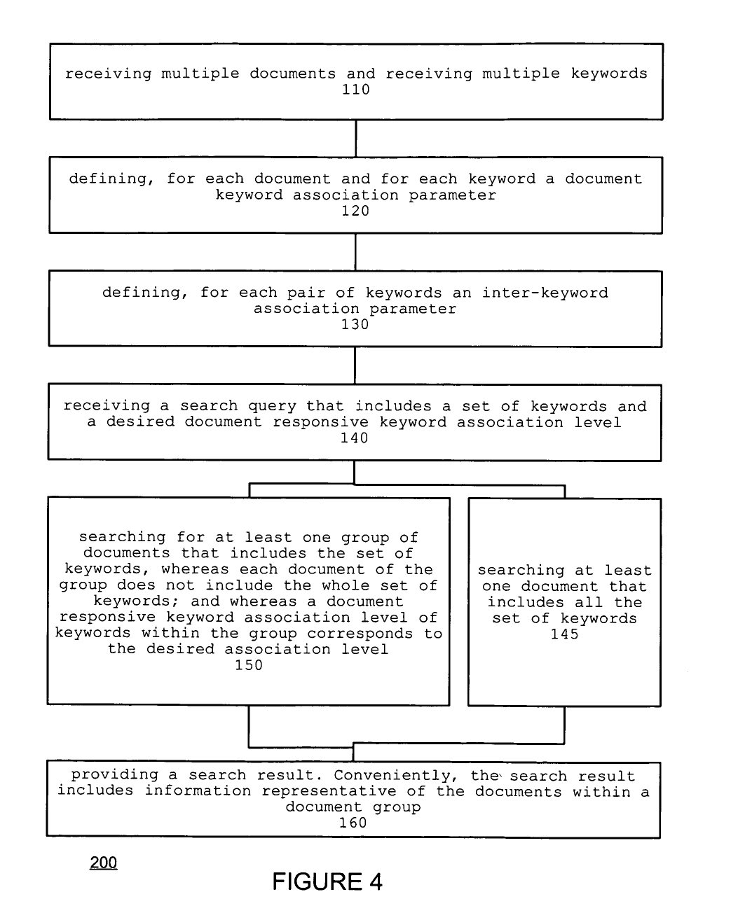

FIG. 4 illustrates a data retrieval method 200, according to another embodiment of the invention.

Method 200 differs from method 100 by including an additional stage 145 of searching at least one document that includes all the set of keywords. The search result provided during stage 160 can reflect the documents that were found during stages 150 and 154.

According to other embodiments of the invention a search query is processed before being used to retrieve documents. The search can include various operations such as parsing or stemming.

The present invention can be practiced by employing conventional tools, methodology and components. Accordingly, the details of such tools, component and methodology are not set forth herein in detail. In the previous descriptions, numerous specific details (such as a certain compression standard) are set forth in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

We claim:

1. A data retrieval method comprising:
receiving a query that comprises a set of keywords and at least one desired document responsive keyword association level; and
searching for at least a group of documents that comprises the set of keywords, whereas each document of the group does not comprise the set of keywords; and whereas an association level between the documents of the groups corresponds to the at least one desired association level.

2. The method of claim 1 further comprising a stage of defining document keyword association parameters and inter-keyword association parameters.

3. The method of claim 2 wherein a document responsive keyword association level between keywords within the group of documents is responsive to inter-keyword association parameters associated with said keywords and to document keyword association parameters associated with said keywords and documents.

4. The method of claim 2 wherein the stage of defining is responsive to users inputs.

5. The method of claim 1 further comprising a stage of performing a location based proximity search.

6. The method of claim 1 further comprising providing a search result.

7. The method of claim 6 wherein the search result includes information representative of the documents within a document group.

8. A data retrieval method comprising:
receiving a search query that comprises a set of keywords and at least one desired document responsive keyword association level;
searching at least one document that comprises all the set of keywords; and
searching for at least one group of documents that comprises the set of keywords, whereas each document of the group does not comprise the set of keywords; and whereas a document responsive keyword association level between the keywords within each group corresponds to the at least one desired association level.

9. The method of claim 8 further comprising a stage of defining document keyword association parameters and inter-keyword association parameters.

10. The method of claim 9 wherein a document responsive keyword association level between keywords within the group of documents is responsive to inter-keyword association parameters associated with said keywords and to document keyword association parameters associated with said keywords and documents.

11. The method of claim 10 wherein the stage of defining is responsive to users inputs.

12. The method of claim 8 further comprising a stage of performing a location based proximity search.

13. The method of claim 8 further comprising providing a search result.

14. The method of claim 13 wherein the search result includes information representative of the documents within a document group.
